(19) United States
(12) Patent Application Publication
(10) Pub. No.: US 2002/0195535 A1
(43) Pub. Date: Dec. 26, 2002

(54) Height adjustment mechanism

(76) Inventors: J. David Carlson, Cary, NC (US); Richard P. Thorn, Erie, PA (US); Robert H. Marjoram, Holly Springs, NC (US)

Correspondence Address: Lord Corporation, 111 Lord Drive, PO Box 8012, Cary, NC, 27512-8012, US

(21) Appl. No.: 10/229,471

(22) Filed: Aug. 28, 2002

Related U.S. Application Data
(62) Division of application No. 09/631,560, filed on Aug. 3, 2000.

(51) Int. Cl. F16M 13/00

(52) U.S. Cl. 248/575

(57) ABSTRACT

A chair height adjustment mechanism includes an energy storage unit which has a compressible fluid. This compressible fluid allows the compressible fluid displaced by the piston rod entering the cylinder, to store energy for subsequent use as the chair seat is raised. This fluid may be of the type that has a dual phase at room temperature such that increase in pressure on the compressible fluid causes a portion of that compressible fluid to transition from gaseous phase to liquid phase. This makes the energy storage unit a constant force spring. The features of this constant force spring may be used in a conventional piston cylinder, shock absorbing device, as well.

### BACKGROUND OF THE INVENTION

1. Field of the Invention

The present invention is directed to chair height adjustment mechanisms. More particularly, the present invention is directed to improvements to the adjustment mechanism described and claimed in U.S. Pat. No. 5,511,759 which is hereby incorporated by reference.

2. Brief Description of the Related Art

Generally, height adjustment mechanisms comprise a piston and a cylinder connected to a reservoir. To telescopically extend the system, fluid is transferred from the reservoir to the cylinder forcing the piston outward. Conversely, to telescopically contract the system, fluid is transferred from the cylinder to the reservoir, drawing the piston inward. A valve between the cylinder and the reservoir controls the flow of the fluid. Typically an incompressible liquid, such as hydraulic fluid, is used. Thus, once the desired height is selected the valve is closed, trapping the fluid in the cylinder and maintaining the desired height position. When the pressure within the reservoir is greater than the outside ambient pressure, a condition known as preload is achieved. Preload forces the piston outward when the valve is open and no load is applied to the piston. This allows a user to extend the height adjustment to its maximum height and then apply a load until the desired height is reached and then close the valve setting the height. An invention of the U.S. Pat. No. 5,511,759 patent uses an expandable elastomeric chamber to provide preloaded pressure to the piston and cylinder such that the device will telescopically expand when the valve is open and the device is not subject to a load.

### SUMMARY OF THE INVENTION

According to a first exemplary embodiment of the present invention, a height adjustment mechanism comprises (a) an outer support tube having a first closed end and a second open end, (b) an inner support tube assembly telescopically received within said outer support tube, said inner support tube assembly including an external tube, an internal tube disposed within said external tube, first means sealing and interconnecting said external and internal tubes at a first pair of ends and second means sealing and interconnecting said external and internal tubes at a second pair of ends thereof, said external tube and said internal tube defining a first chamber there between, (c) a piston assembly interconnected to said outer support tube and telescopically received within said internal tube, said internal tube and said piston assembly defining a second chamber there between, (d) port means allowing fluid flow between said first and second fluid chambers, (e) a hydraulic fluid contained within said port means and said first and second chambers, (f) valve means interactive within said port means for regulating fluid flow between said first and second chambers, and (g) energy storage means including a pressurized fluid cooperating with said first chamber to provide a lift force upon opening said valve means to allow flow of said hydraulic fluid between said outer support tube and said inner support tube assembly.

According to a second exemplary embodiment of the present invention, a height adjustment mechanism comprises (a) an outer support tube having a first closed end and a second open end, (b) an inner support tube assembly telescopically received within said outer support tube, said inner support tube assembly including an external tube, an internal tube disposed within said external tube, (c) first means sealing and interconnecting said external and internal tubes at a first end including an elastomeric sleeve encircling said internal tube and having a thin, more flexible portion which permits said valve means to be moved between a first closed position and a second open position said first means supporting said valve means and biasing said closeable valve means to said first closed position, (d) second means sealing and interconnecting said external and internal tubes at a second end thereof, said external tube and said internal tube defining a first chamber there between, (e) a piston assembly interconnected to said outer support tube and telescopically received within said internal tube forming a second chamber, (f) port means allowing fluid flow between said first and second fluid chambers, (g) a hydraulic fluid contained within said port means and said first and second chambers, (h) valve means interactive within said port means for regulating fluid flow between said first and second chambers, and (i) a pressurized gas cooperating with said first chamber to provide a preload lift force upon opening said closeable valve to telescopically extend said inner support tube assembly relative to said outer support tube.

According to a third exemplary embodiment of the present invention, a constant force spring comprises (a) a piston cylinder having a first closed end, (b) a piston received and slidable within said piston cylinder, (c) a first chamber defined between said first closed end of said piston cylinder and said piston, (d) seal means provided on said piston sealing said piston against said piston cylinder making said first chamber substantially leakproof, and (e) a fluid confined within said first chamber, said fluid being in said first chamber will be partially liquid and partially gaseous with vapor pressures at room temperature in the range of between 50 psi and 150 psi such that a compressive force on said first chamber by said piston will cause a portion of said gaseous fluid to move into a liquid state exhibiting a constant force opposing said compressive force.

According to a fourth exemplary embodiment of the present invention, a means for controlling flow of hydraulic fluid in a piston cylinder comprises a valve member comprising (a) an elastomeric sleeve portion which fits over an inner support tube and seals against said inner support tube to prevent undesired fluid flow between said elastomeric sleeve portion and said inner support tube, said elastomeric sleeve portion including passageway means to permit desired flow of hydraulic fluid between said elastomeric sleeve portion and said inner support tube, said elastomeric sleeve portion fitting within an outer support tube and being sealed with respect thereto to prevent undesired flow of hydraulic fluid between said elastomeric sleeve portion and said outer support tube, (b) a flexible intermediate section interconnected to said elastomeric sleeve portion, (c) a generally tabular portion extending outwardly from said flexible intermediate section, (d) a rigid valve seat element which has i) a stem portion extending through an end portion of said inner support tube, a portion of said stem portion being received within said generally tubular portion, and ii) a flat valve seat projecting from said stem portion that abuts and seals against an inner surface portion of said inner support tube, and (e) a manually engageable valve actuator having a portion which surrounds an upper periphery of said generally tubular portion, whereby when said manually engageable valve actuator is depressed, said generally tubular portion is moved axially unseating said valve seat from said inner surface portion of said inner support tube permitting hydraulic fluid within said inner support tube to flow in a direction to and from said outer support tube through said passageway means.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus and method, given only by way of example, and with reference to the accompanying drawings, in which:

FIG. 1A is a longitudinal cross-sectional view of a first preferred embodiment of the height adjustment mechanism of the present invention that can use any one of FIG. 2A, 2B, 2D, or 2F, depicting preferred embodiments of energy storage devices;

FIG. 1B is a longitudinal cross-sectional view of a second preferred embodiment of the height adjustment mechanism of the present invention;

FIG. 2A is a longitudinal cross-sectional view of a first embodiment of an energy storage device useful in the height adjustment mechanism of the present invention;

FIG. 2B is a longitudinal cross-sectional view of a second preferred embodiment of an energy storage device useful in the height adjustment mechanism of the present invention;

FIG. 2C is a partial view of the sealing means of the energy storage device in the circled area of FIG. 2B;

FIG. 2D is an exploded side view in partial section of a third embodiment of the energy storage device;

FIG. 2E is a side view of a fourth embodiment of the energy storage device prior to final assembly;

FIG. 2F is a longitudinal cross-sectional view depicting the fourth embodiment of the energy storage device of FIG. 2E in final assembly.

FIG. 3 is a cross-sectional side view of a third embodiment of the height adjustment mechanism of the present invention;

FIG. 4 is a longitudinal cross-sectional view of a fourth embodiment of the height adjustment mechanism of the present invention;

FIG. 5 is a longitudinal cross-sectional view of a fifth embodiment of the height adjustment mechanism of the present invention; and

FIG. 6 is a longitudinal cross-sectional view of an embodiment of a constant force spring of the present invention.

### DESCRIPTION OF THE PREFERRED EMBODIMENTS

The improvements of the subject invention include improved reliability and consistency of performance, reduced manufacturing expense, elimination of critical leak paths, and improved preload capability. Revision of the fluid channel, valve and seal mechanisms to perform these tasks with a single element at a point internal to the outermost periphery of the unit serves to eliminate the leakage while improving the consistency of performance of the valve and reducing manufacturing costs.

The preload provided to the system by the system adjustment mechanism is important because when the adjustment mechanism is used in combination with a repositionable device such as a chair, for example, and the valve is open and the seat unloaded, the mechanism will rise to its upper position to be in a position for ready adjustment. In addition, the preload serves to increase the amount of energy stored by the descent of the loaded chair during adjustment. Several embodiments of improved means to achieve preload are taught by this disclosure. These embodiments chiefly entail some form of elastomeric bladder which can be inflated to a desired pressure to provide the desired preload. These bladders are inserted into a reservoir having rigid walls where the preload is achieved by the bladder(s) being compressed by the surrounding hydraulic fluid. These bladders can also be filled with a fluid that is in two phases (gas and liquid) at a desired pressure and temperature. This allows for the pressure to remain constant as the internal volume of the bladder changes, provided two phases are present. The constant pressure provides uniform fluid flow from the reservoir to the cylinder when the valve is open and no load is applied to the piston for extending the height adjustment mechanism to the maximum extended position. The constant pressure eliminates the potential problem of having too much pressure when the piston is at the bottom of the cylinder and too little pressure when the piston is extended to the top of the cylinder.

Another aspect of the invention is the provision of a constant force spring. The constant force spring works on the same principle as described above. A working fluid having gas and liquid phases at normal, or desired, operating temperatures and pressures exerts a constant pressure against a piston for the full range of motion of the piston within a cylinder. Provided the working fluid remains in a two phase state, the force against the piston will be constant for the full range of motion forming a constant force spring. Suitable working gases include, but are not limited to, HF₆, 1,1,1,2-tetrafluoroethane, pentafluoroethane, difluoroethane, and 1,1,1-trifluoroethane, and preferably, but not necessarily, are non-toxic, nonflammable, and non-ozone depleting. When the piston compresses the gas phase of this fluid, the gas phase will be converted to liquid rather than increasing the internal pressure within the piston cylinder. The two phase fluid can be either a primary fluid or a secondary fluid used in conjunction with an incompressible liquid-phase fluid, such as hydraulic fluid. Such hydraulic fluids might include castor oil, glycerol and various glycols. In other applications, this constant force spring can provide a low stiffness mounting that will provide excellent vibration isolation, particularly at low frequency.

Referring to the drawing figures, like reference numerals designate identical or corresponding elements throughout the several figures.

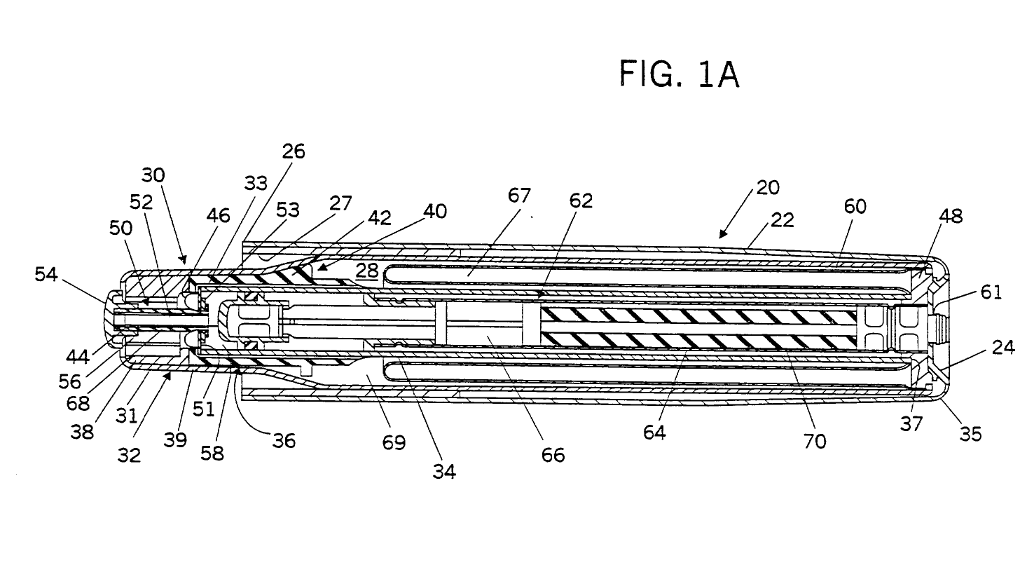

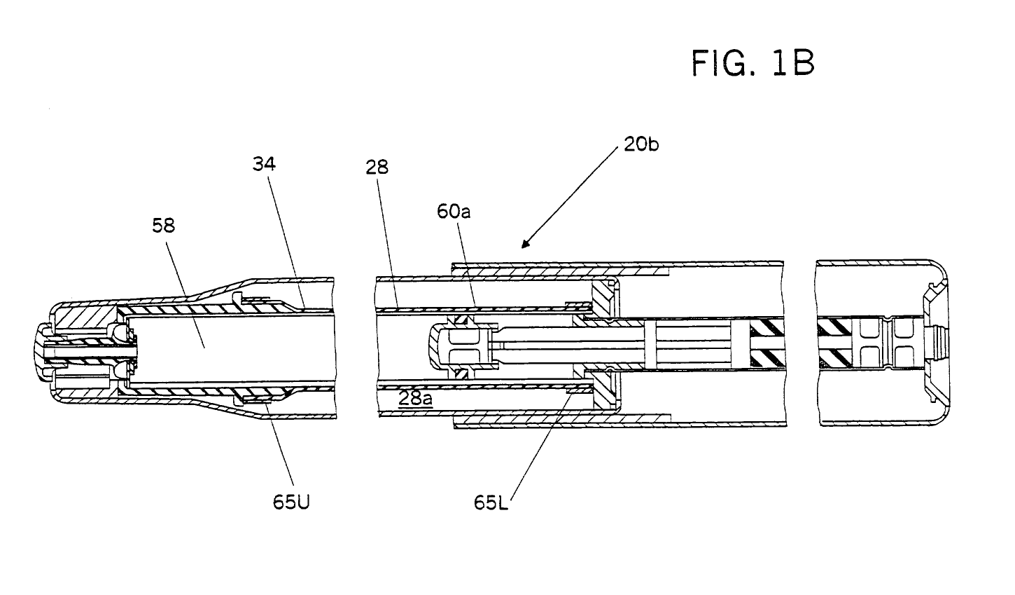

A first preferred embodiment of the height adjustment mechanism of the present invention is shown in FIG. 1A, generally at 20. Height adjustment mechanism 20 includes an outer support tube 22 which is closed on a first end 24 and open on a second end 26 and an inner support tube assembly 30 is telescopically received within and protruding from the second open end 26 of the outer support tube 22. A sleeve 27 of self-lubricating bearing material is affixed within the open end 26 of outer support tube 22. Inner tube assembly 30 includes an external tube 32 and an internal tube 34 disposed therein. External tube 32 and internal tube 34 are sealed and connected together at first ends 31 and 33 by first sealing and connecting means 36. First sealing and connecting means 36 includes a spacer 38, O-ring 39, and elastomeric element 40.

Elastomeric element 40 is a unitary member including sleeve portion 42 that fits over internal tube 34; a smaller diameter cylindrical portion 44 that receives a stem portion 52 of valve element 50; a thin, flexible portion 46 interconnecting sleeve 42 and cylindrical portion 44 which permits the valve element 50 to be moved between a first closed position (shown in FIG. 1A) in which valve 53 engages valve seat 51 and a second open position by means of a manually engageable valve actuator 54, the first sealing and connecting means supporting the valve element 50 and biasing the closeable valve element 50 to its closed position. Valve actuator 54 has a cylindrical portion 56 which surrounds an upper end of cylindrical portion 44.

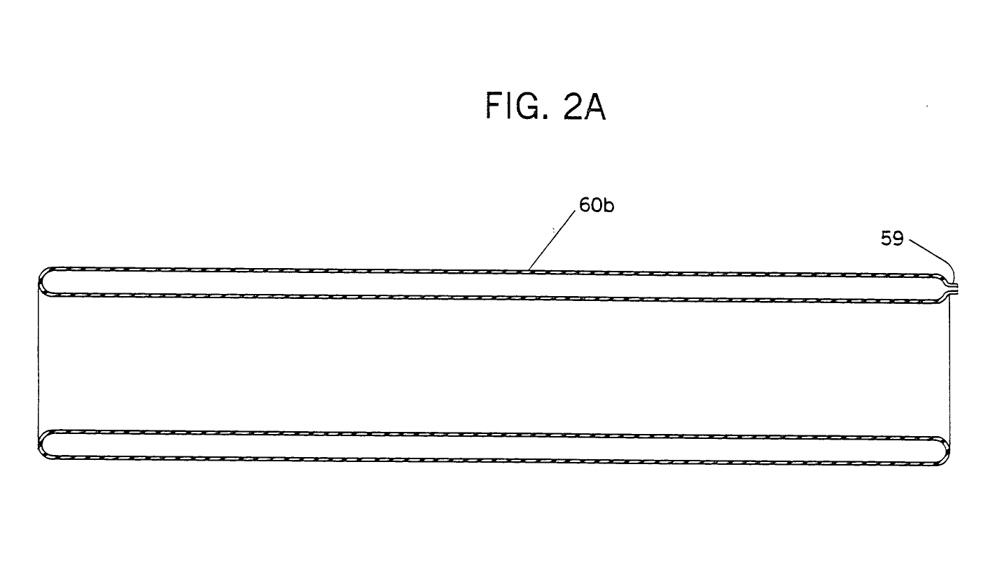

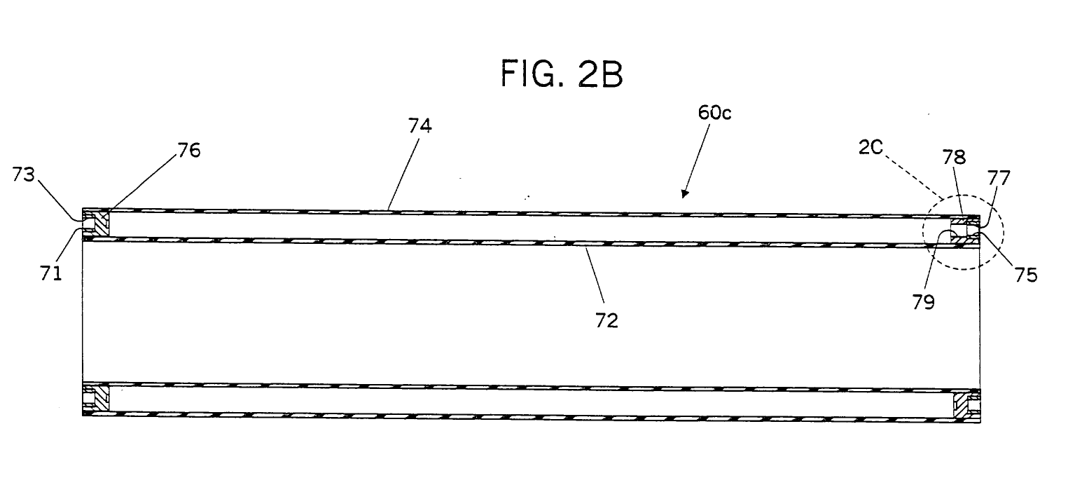

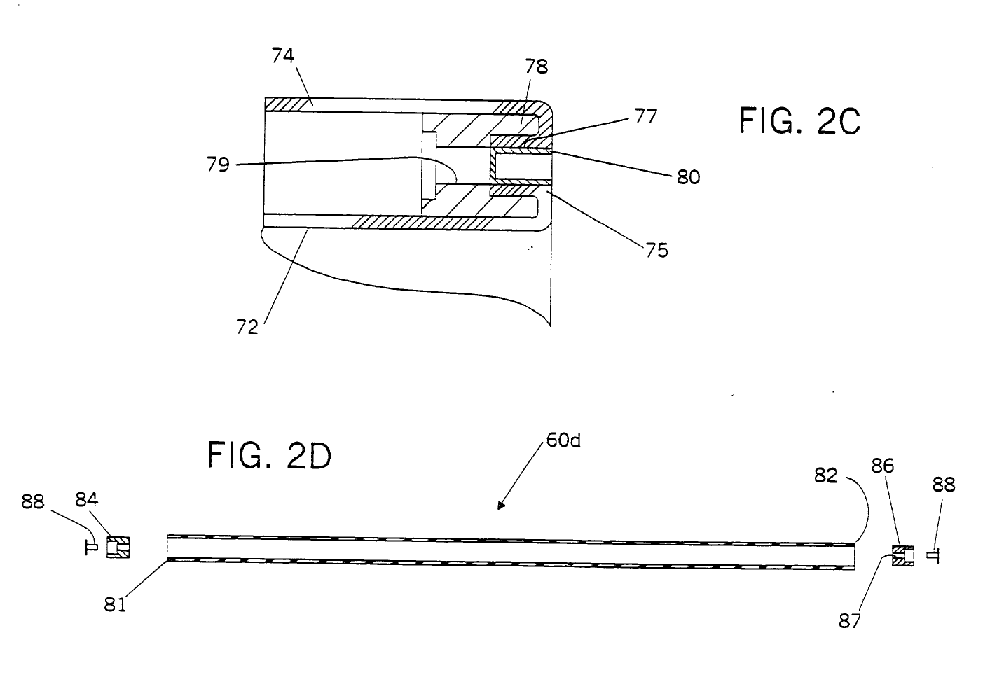

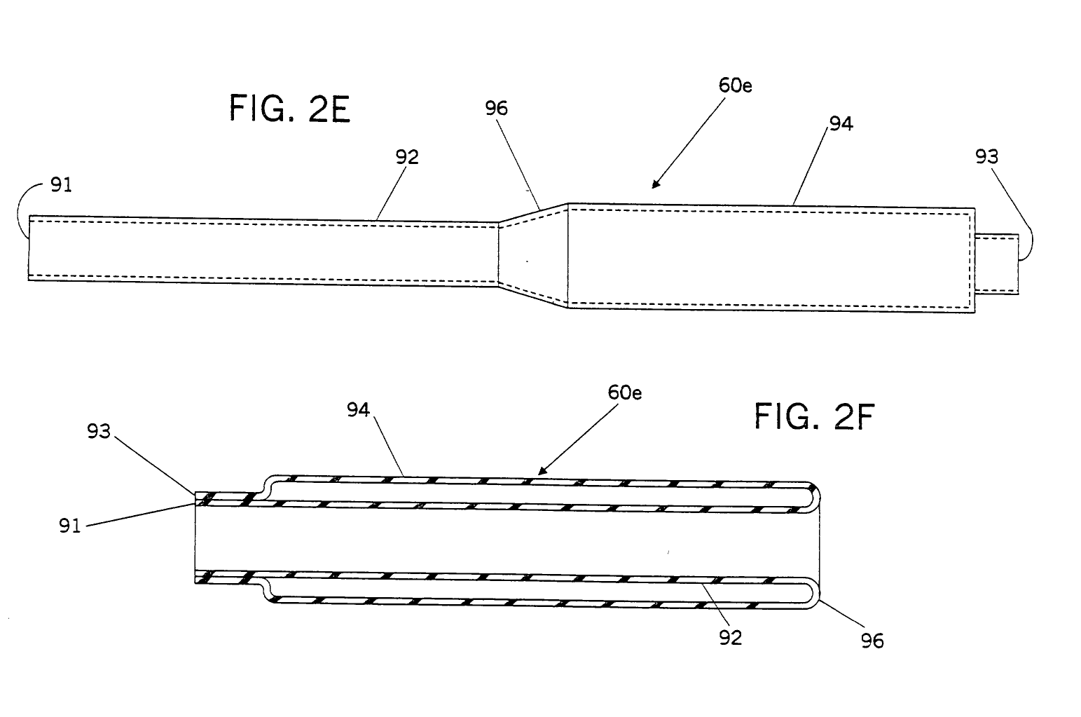

External tube 32 and internal tube 34 are interconnected and sealed at second ends 35 and 37, respectively, by a second connecting and sealing means 48. This sealed area between external tube 32 and internal tube 34 includes a first annular shaped chamber 28. In the FIG. 1A embodiment, sealing element 48 also captures the ends of a thin-walled elastomeric bladder 60 between itself and the external tube 32 and internal tube 34. The interior 67 of bladder 60 can be inflated with a secondary fluid to a desired pressure level (e.g., between about 50 psi (345 kPa) and about 200 psi (1380 kPa)) through an opening (not shown) in sealing element 48 forming an energy storage device to provide a desired preload. The thin walled elastomeric bladder 60 can be any one of the preferred embodiments of energy storage devices of FIG. 2A, 2B, 2D, or 2F, inserted in place of bladder 60 in chamber 28. Gases suitable as a secondary fluid include air, dry nitrogen, and carbon dioxide, depending on the choice of elastomeric material of bladder 60. Examples of materials suitable for bladder 60 are natural rubber, nitrile, and butyl. If constant pressure is desired, the interior 67 of bladder 60 can be filled with a secondary fluid comprising a two phase fluid that is in the form of liquid and gas at the desired pressure and temperature. By way of example and not of limitation, a secondary fluid can be a two-phase fluid at a temperature of about 75° F. (24° C.) at a pressure of between about 50 psi (345 kPa) and about 150 psi (1035 kPa). The preload offsets the weight of the chair seat itself and provides a lifting force when the valve is opened to restore the chair seat to an upper most position for subsequent adjustment. By controlling the size of the opening between valve 53 and valve seat 51, the chair operator can control the rate at which the operating fluid 69 passes through the valve and, hence, the rate of descent of the chair.

A piston rod assembly 62 is received within inner tube 34, extends through second seal element 48 and is attached to outer support tube 22 at 61. Piston rod assembly includes a housing 64, a piston rod 66, a piston head 68 and a cush 70. A second chamber 58 is defined by inner tube 34 and piston assembly 62. First chamber 28 and second chamber 58 are filled with an operating fluid 69; operating fluid 69 is preferably hydraulic fluid, and when valve 53 is opened, fluid can flow between first chamber 28 and second chamber 58, depending on which chamber has the higher fluid pressure level. If the chair operator is not seated on the chair, the pressure in first chamber 28 will exceed the pressure in second chamber 58 because of the preload delivered by the energy storage device of bladder 60. If the operator is seated, whether or not the seat has been extended to its upper position, but not at the minimum height, unseating valve 53 will cause fluid to flow from chamber 58 to chamber 28 as the chair is lowered under the operator's weight until the operator releases the valve actuator 54 or the minimum height is reached.

A second embodiment of the height adjustment mechanism of the present invention is shown in FIG. 1B, generally at 20b. The second embodiment height adjustment mechanism 20b includes many of the elements of the first embodiment height adjustment mechanism shown in FIG. 1A, and also includes bands 65U, 65L, bladder 60a and chamber 28a. In this embodiment, thin walled elastomeric bladder 60a is attached around internal tube 34 by bands 65U and 65L. First chamber 28a does not contain an operating fluid 69 but, rather, is pressurized by a secondary fluid, as described in FIG. 1A, forming an energy storage device to provide the desired preload, and when valve 53 is opened while the operator is seated, the fluid bulges bladder 60a outwardly against the preload pressure in chamber 28a, in effect, storing energy for later use. This embodiment functions equivalently to that of FIG. 1A above in that the preload provides a pressure imbalance between first chamber 28 (the space between bladder 60a and internal tube 34) and second chamber 58 such that when the chair is not loaded and the valve is opened fluid flows in to second chamber 58 raising the level of the chair. The height of the chair is adjusted by the user sitting on the chair and releasing the valve until the desired height is achieved.

FIG. 2A depicts a first preferred embodiment of an energy storage device generally at 60b. Storage device 60b is a thin walled bladder that has been molded into a cylinder with a fill port 59. Once bladder 60b has been filled with a secondary fluid to the desired pressure, fill port 59 can be mechanically plugged or heat sealed. As with the previous embodiments, the cylindrical bladder 60b is positioned in first chamber 28 directly in the operating fluid 69 to provide a preload to the operating fluid 69.

FIGS. 2B and 2C depict a second preferred embodiment of a energy storage device generally at 60c. Energy storage device 60c includes a first inner elastomeric tube 72 and a second outer elastomeric tube 74. The preferred materials for the inner elastomeric tube 72 and outer elastomeric tube 74 are natural rubber, nitrile, or butyl. A closure ring 76 closes off a first pair of ends 71 and 73, respectively, of tubes 72 and 74. A second closure ring 78 closes off a second pair of ends 75 and 77, respectively, of tubes 72 and 74 (see FIG. 2C detail). The preferred materials for the closure rings are nylon, steel, or aluminum. The ends 71 and 73 are wrapped around closure ring 76 and ends 75 and 77 around closure ring 78. An expandable plug or series of plugs 80 can be inserted into the slots in closure rings 76 and 78 and expanded like a rivet to lock them in place. Expandible plugs can take the form of metal double-walled, semi-annular ring segments, the lower extremity of the walls being deflectable outwardly to lock in the slots in closure rings 76 and 78. Energy storage device 60c can be inflated with a secondary fluid to the desired pressure through an opening 79 and then plugged by expandable plugs 80. As with the previous embodiments, the energy storage device 60c is positioned in first chamber 28 directly in the operating fluid 69 to provide a preload to the operating fluid 69.

A third preferred embodiment of the energy storage device is shown in FIG. 2D generally at 60d. Bladder 60d comprises a cylindrical tube whose ends are sealed by closure members 84 and 86. The preferred materials for the closure members 84 and 86 are nylon, steel, or aluminum. The bladder 60d is preferably made from natural rubber, nitrile, or butyl. The extremities 81 and 82 are wrapped around members 84 and 86 and secured by expandable plugs 88. Plug 88 is used to close off fill port 87, as well as anchor end 84 of tube 60d. Tube(s) 60d can be pre-pressurized with a secondary fluid and as many tubes may be added to chamber 28 as are needed to provide the desired level of preload.

A fourth preferred embodiment of the energy storage device of the present invention is depicted in FIGS. 2E and 2F, generally at 60e. In this embodiment bladder 60e is formed as a molded tube having a first section 92, a second section 94, and a tapered transitional section 96 connecting the first and second sections. First section 92 is pulled through section 94 and, once the bladder 60e is pressurized with a secondary fluid to a desired level to provide the desired preload, the two ends 91, 93 can be bonded together and sealed, as shown in FIG. 2F. As with the previous embodiments, the cylindrical bladder 60e is positioned in first chamber 28 directly in the operating fluid 69 to provide a preload to the operating fluid 69. The preferred materials for the bladder are rubber, nitrile, and butyl.

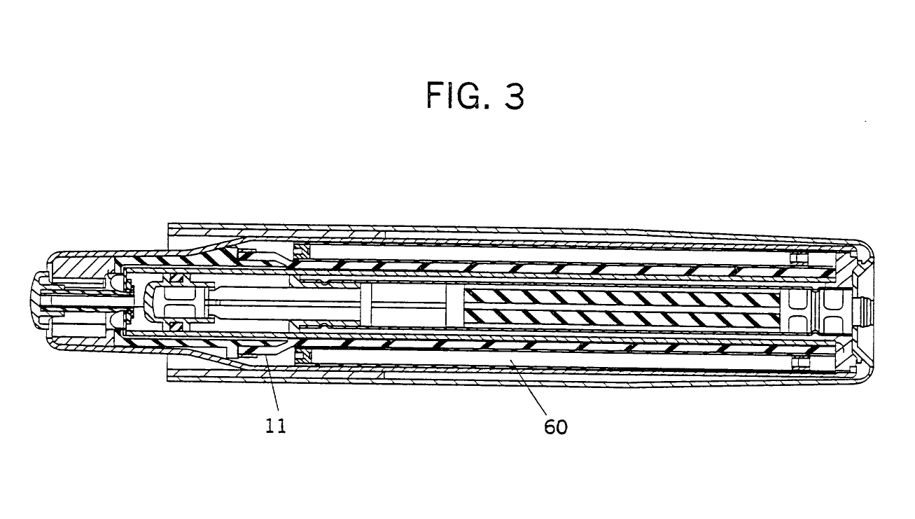

FIG. 3 shows a third embodiment of the height adjustment mechanism of the present invention. While the thin walled bladder of earlier embodiments is preferred due to the material savings and the resultant reduced cost, the benefits of the present invention can be realized with conventional thick walled bladders 11 of the type used in U.S. Pat. No. 5,511,759. Simply adding an energy storage device from any of the embodiments of FIGS. 2A-2E to that of FIG. 2D, shown here as 60d of FIG. 2D, will provide the improved preload pressurization that this invention makes available.

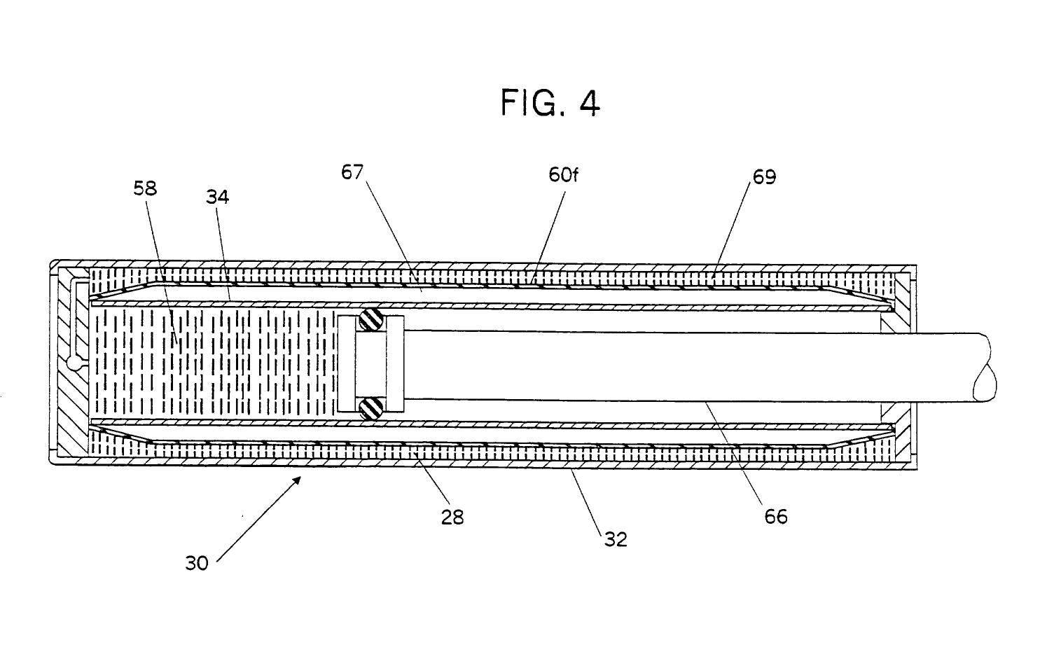

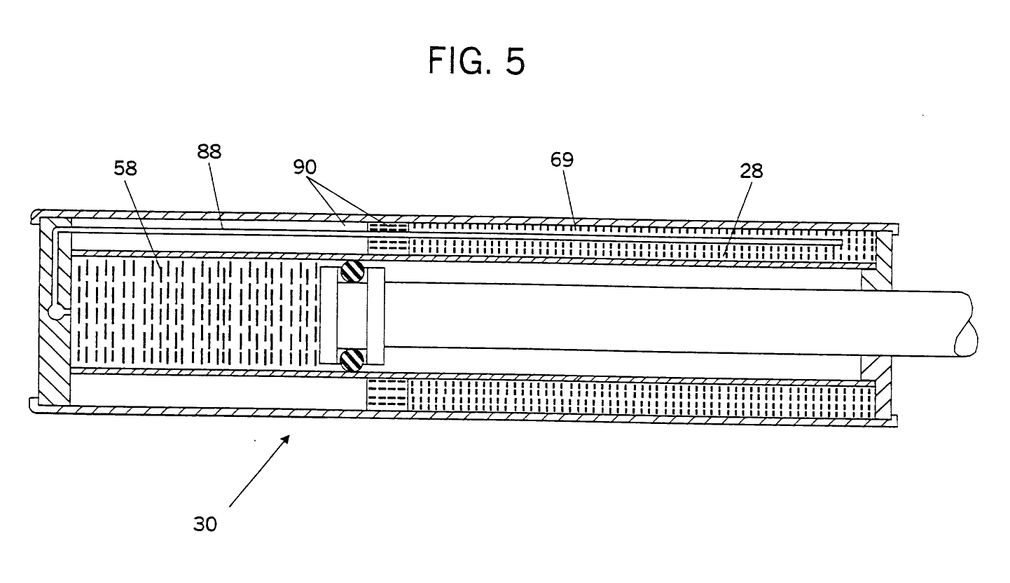

Another aspect of the present invention is depicted in FIGS. 4-6. In FIGS. 4 and 5, this aspect is shown as embodied as a pressurized accumulator in a device such as the inner tube assembly 30 of the chair height adjuster of FIG. 1A discussed above. In FIG. 4, operating fluid 69 is pumped between first chamber 28 and second chamber 58 by piston 66, while a secondary fluid is captured between bladder 60f and internal tube 34 forming interior space 67 creating an energy storage device. The secondary fluid is present as an equilibrium combination of both liquid and gaseous phases. The internal pressure of the interior space 67 is maintained at the vapor pressure of the gas as long as some liquid phase is present. Movement of piston 66 inward causes the gas to compress. However, rather than elevating the pressure, some of the gas is converted to liquid such that the internal pressure remains generally constant dependent on the secondary fluid temperature. Preferred secondary fluids include, but are not limited to, substitutes for Freon-12 such as: 1,1,1,2-tetrafluoroethane; pentafluoroethane; difluoroethane; and 1,1,1-trifluoroethane, all of which exhibit vapor pressures in the range of approximately 50 to 150 PSI (345 to 1035 kPa) for fluid temperatures in the range of 60-100° F. (16-38° C.). Thus, the force of the pressure of the secondary fluid against bladder 60f is transferred to primary fluid 69, maintaining a generally constant force against piston 66 and creating a generally constant force spring.

FIG. 5 depicts an alternate embodiment of the constant force spring of FIG. 4 in which the secondary fluid 90 is simply mixed with the operating fluid 69. The differences in density will typically cause the secondary fluid 90 to float atop the operating fluid 69 whereby the space occupied by the secondary fluid 90 of chamber 28 acts as an energy storage device. Siphon tube 88 permits the denser primary working fluid 69 to move between first chamber 28 and second chamber 58 through the secondary fluid 90 floating atop the primary fluid 69 in first chamber 28.

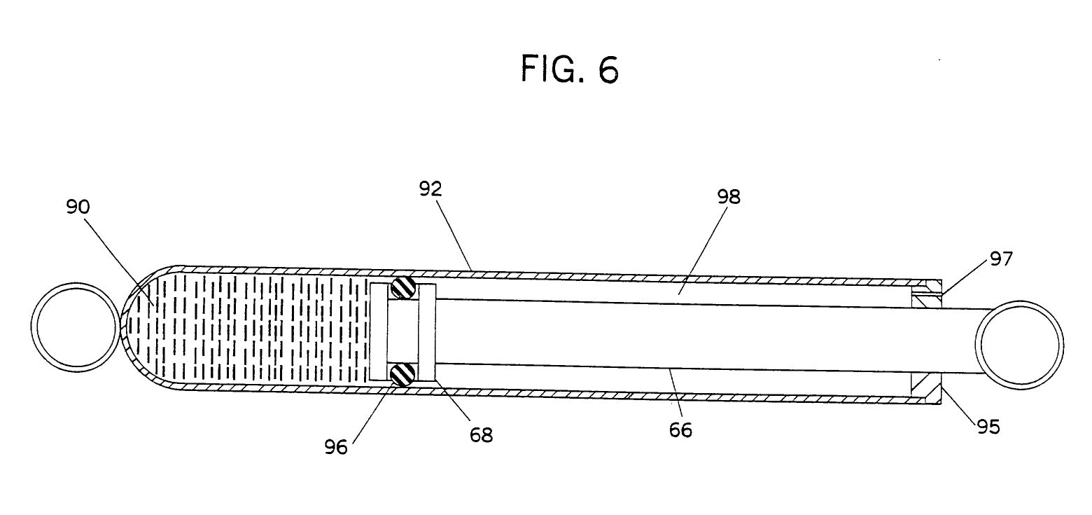

FIG. 6 applies the teachings of a constant force spring to a conventional piston cylinder 92 that can be utilized to isolate sensitive equipment such as electronic devices, from low frequency vibrations. The piston 66 in cylinder 92 has low mechanical stiffness and any vibrational movement of the equipment being protected will be dampened by the transition of the working fluid 90 between its gaseous and fluid phases, in lieu of creating a rise in internal pressure, forming a constant force spring. Air vent 97 is provided in bushing 95 so that air can flow to and from the chamber 98 formed by cylinder 92, piston head 68, and bushing 95. The airflow permitted by air vent 97 prevents pressure fluctuations in chamber 98 that could reduce the effectiveness of the constant force spring. Piston head 68 has an O-ring seal 96 to prevent gas from escaping from the system. Even if a small amount of the gaseous phase escaped from the cylinder 92, the fluid phase would replace it maintaining equilibrium pressure between the fluid and gas phases. Accordingly, the constant force spring of the subject invention will continue to function properly until the liquid phase of the secondary fluid 90 is depleted.

While the invention has been described in detail with reference to preferred embodiments thereof, it will be apparent to one skilled in the art that various changes can be made, and equivalents employed, without departing from the scope of the invention.

What is claimed is:

1. A height adjustment mechanism, comprising:
(a) an outer support tube having a first closed end and a second open end;
(b) an inner support tube assembly telescopically received within said outer support tube, said inner support tube assembly including an external tube, an internal tube disposed within said external tube, first means sealing and interconnecting said external and internal tubes at a first pair of ends and second means sealing and interconnecting said external and internal tubes at a second pair of ends thereof, said external tube and said internal tube defining a first chamber there between;
(c) a piston assembly interconnected to said outer support tube and telescopically received within said internal tube, said internal tube and said piston assembly defining a second chamber there between;
(d) port means allowing fluid flow between said first and second fluid chambers;
(e) a hydraulic fluid contained within said port means and said first and second chambers;
(f) valve means interactive within said port means for regulating fluid flow between said first and second chambers; and
(g) energy storage means including a pressurized fluid cooperating with said first chamber to provide a lift force upon opening said valve means to allow flow of said hydraulic fluid between said outer support tube and said inner support tube assembly.

2. The apparatus of claim 1 wherein said energy storage means comprises an expansible chamber located within said first chamber, said expansible chamber containing said pressurized fluid.

3. The apparatus of claim 2 wherein said expansible chamber is in the form of an elastomeric bladder.

4. The apparatus of claim 3 wherein said elastomeric bladder is fully surrounded by said hydraulic fluid within said first fluid chamber.

5. The apparatus of claim 3 wherein said elastomeric bladder comprises a flexible, compressible element with low gas/fluid permeability.

6. The apparatus of claim 3 wherein said elastomeric bladder has low gas/fluid permeability and is selected from the group consisting of multilayered laminated polymeric films and multilayered extruded elastomeric elements.

7. The apparatus of claim 4 wherein a first pressure in said elastomeric bladder is substantially equal to a second pressure of said hydraulic fluid in said first fluid chamber resulting in a near zero pressure differential across said elastomeric bladder.

8. The apparatus of claim 2 wherein said expansible chamber is further comprised of first and second substantially concentric elastomer tubes sealed at first and second ends.

9. The apparatus of claim 8 wherein said first and second substantially concentric elastomer tubes are formed as opposed ends of a continuous elastomeric extrusion interconnected by a tapered transition region.

10. The apparatus of claim 1 wherein said first means sealing and interconnecting said external and internal tubes includes an elastomeric sleeve encircling said internal tube and having a thin, flexible portion which permits said valve means to be moved between a first closed position and a second open position, said first means supporting said valve means and biasing said closeable valve means to said first closed position.

11. The apparatus of claim 1 wherein said pressurized fluid of said energy storage means comprises a gas, compression of said gas causing a portion of said gas to change to a liquid whereby an internal pressure within said first fluid chamber remains substantially constant.

12. The apparatus of claim 11 wherein said pressurized fluid of said energy storage means is selected from a group consisting of refrigerants developed to replace Freon 12 including HF₆ 1,1,1, 2-tetrafluorethane, pentaflouroethane, difluoroethane, and 1,1,1-trifluoroethane.

13. A height adjusting apparatus, comprising:
(a) an outer support tube having a first closed end and a second open end,
(b) an inner support tube assembly telescopically received within said outer tube, said inner support tube assembly including an external tube, an internal tube disposed within said external tube,
(c) first means sealing and interconnecting said external and internal tubes at a first end including an elastomeric sleeve encircling said internal tube and having a thin, more flexible portion which permits said valve means to be moved between a first closed position and a second open position said first means supporting said valve means and biasing said closeable valve means to said first closed position,
(d) second means sealing and interconnecting said external and internal tubes at a second end thereof, said external tube and said internal tube defining a first chamber there between,
(e) a piston assembly interconnected to said outer support tube and telescopically received within said internal tube forming a second chamber,
(f) port means allowing fluid flow between said first and second fluid chambers,
(g) a hydraulic fluid contained within said port means and said first and second chambers,
(h) valve means interactive within said port means for regulating fluid flow between said first and second chambers, and
(i) a pressurized gas cooperating with said first chamber to provide a preload lift force upon opening said closeable valve to telescopically extend said inner support tube assembly relative to said outer support tube.

14. The apparatus of claim 13 wherein said first means for sealing and interconnecting includes passageways formed therein to facilitate movement of hydraulic fluid between said first and second chambers.

15. A constant force spring comprising:
(a) a piston cylinder having a first closed end;
(b) a piston received and slidable within said piston cylinder;
(c) a first chamber defined between said first closed end of said piston cylinder and said piston;
(d) seal means provided on said piston sealing said piston against said piston cylinder making said first chamber substantially leakproof,
(e) a fluid confined within said first chamber, a compressive force on said first chamber by said piston causing a portion of said gaseous fluid to change into a liquid state exhibiting a constant force opposing said compressive force.

16. A constant force gas spring in accordance with claim 15, wherein said fluid is partially liquid and partially gaseous with vapor pressures in the range of between 50 psi and 150 psi.

17. Means for controlling flow of hydraulic fluid in a piston cylinder comprising:
a valve member including:
(a) an elastomeric sleeve portion which fits over an inner support tube and seals against said inner support tube to prevent undesired fluid flow between said elastomeric sleeve portion and said inner support tube, said elastomeric sleeve portion including passageway means to permit desired flow of hydraulic fluid between said elastomeric sleeve portion and said inner support tube, said elastomeric sleeve portion fitting within an outer support tube and being sealed with respect thereto to prevent undesired flow of hydraulic fluid between said elastomeric sleeve portion and said outer support tube;
(b) a flexible intermediate section interconnected to said elastomeric sleeve portion;
(c) a generally tabular portion extending outwardly from said flexible intermediate section;
(d) a rigid valve seat element which has
i) a stem portion extending through an end portion of said inner support tube, a portion of said stem portion being received within said generally tubular portion, and
ii) a flat valve seat projecting from said stem portion that abuts and seals against an inner surface portion of said inner support tube;
(e) a manually engageable valve actuator having a portion which surrounds an upper periphery of said generally tubular portion;
whereby when said manually engageable valve actuator is depressed, said generally tubular portion is moved axially unseating said valve seat from said inner surface portion of said inner support tube permitting hydraulic fluid within said inner support tube to flow in a direction to and from said outer support tube through said passageway means.

18. The means for controlling flow of claim 17, further comprising:
an energy storage means positioned within said piston cylinder, said energy storage means being compressed by said hydraulic fluid displaced by a piston rod sliding within said piston cylinder.

19. The means for controlling flow of claim 18, wherein said piston rod is connected to an outer support tube and the direction of fluid flow through said passageway means is determined by a force differential between a first gravitational force exerted on said outer support tube and a second fluid force from said energy storage means.
